(19) United States
(12) Patent Application Publication
(10) Pub. No.: US 2023/0063928 A1
(43) Pub. Date: Mar. 2, 2023

(54) COFFEE BEVERAGE MANUFACTURING DEVICE, AND COFFEE BEVERAGE MANUFACTURING PROGRAM

(71) Applicant: Balmuda Inc., Tokyo (JP)

(72) Inventors: Junya URA, Musashino-shi, Tokyo (JP); Takehira OTA, Musashino-shi, Tokyo (JP); Takafumi TAKANI, Musashino-shi, Tokyo (JP)

(21) Appl. No.: 17/796,735

(22) PCT Filed: Feb. 3, 2020
(86) PCT No.: PCT/JP2020/003924

§ 371 Date: Aug. 1, 2022

(51) Int. Cl. A47J 31/56; A47J 31/44

(52) U.S. Cl. CPC A47J 31/56; A47J 31/4475

(57) ABSTRACT

Water fed under pressure by a pump is heated using a heater to become hot water. The hot water flows through a main flow passage and is discharged into a dripper in which coffee ingredients have been set. A temperature control unit controls the heater based on a temperature detected by a temperature sensor that detects the temperature of the hot water, such that the temperature of the hot water reaches a target temperature set in advance by a coffee beverage manufacturing program. In an extracting step for extracting the coffee beverage, a target temperature TTb in a middle stage of the extraction and a target temperature TTc in a later stage of the extraction are lower than a target temperature TTa in an initial stage of the extraction.

### TECHNICAL FIELD

The present invention relates to a coffee beverage production device and a coffee beverage production program, and more particularly to a drip type coffee beverage production device and a coffee beverage production program for extracting a coffee beverage in a drip type system.

### BACKGROUND

Conventionally, a drip type coffee beverage production device is known (for example, Patent Documents 1 and 2). A drip type system is a system in which hot water is delivered to an extraction unit (i.e., a dripper) having set therein a filter (i.e., a paper filter, a flannel filter, etc.) containing a coffee ingredient such as a coffee powder, and a coffee beverage is thereby extracted from the coffee ingredient. According to such a coffee beverage production device, a user can extract a coffee beverage by simply putting water in a water tank of the coffee beverage production device, setting a filter containing a coffee ingredient in the dripper, and pressing the start switch for starting the process.

The coffee beverage production devices disclosed in Patent Documents 1 and 2 have a bypass pipe for directly delivering hot water, without passing through the dripper, to a coffee storage unit (i.e., a server) for storing the extracted coffee beverage. By delivering hot water to the server via the bypass pipe, the concentration of the coffee beverage is adjusted.

### CITATION LIST

### Patent Literature

Patent Document 1: JP 559-85126 U

Patent Document 2: JP H8-185569 A

### SUMMARY

### Technical Problem

Generally, in a drip type system, great amounts of sweetness and acidity components are extracted in an initial stage of extraction immediately after start of extraction of a coffee beverage, and as time passes from the start of extraction, more astringency and harshness components are extracted as compared with the initial stage of extraction.

Further, conventional coffee beverage production devices are often controlled to extract a coffee beverage at a constant extraction temperature. Coffee beverage enthusiasts have a wide variety of taste preferences, and some prefer a coffee beverage having a cleaner taste with little astringency and harshness.

An object of the present invention is to provide a coffee beverage production device capable of extracting a coffee beverage having a cleaner taste with little astringency and harshness, and a production program thereof.

### Solution to Problem

According to the present invention, there is provided a coffee beverage production device including: a heating unit configured to produce hot water by heating water pumped by a pump; a temperature detection unit configured to detect a temperature of the hot water; and a temperature control unit configured to control the heating unit based on a temperature detected by the temperature detection unit such that the hot water reaches a target temperature, wherein, in an extraction step in which the hot water supplied by the pump is delivered to an extraction unit having set therein a coffee ingredient to extract a coffee beverage, as compared with the target temperature in an earlier period of the extraction step, the target temperature in a later period, which is a period of the extraction step following the earlier period, is a lower temperature.

Preferably, the time average value of the target temperature in the later period is a value lower than the time average value of the target temperature in the earlier period.

Preferably, the earlier period is the first-half period of the extraction step, and the later period is the second-half period of the extraction step.

The coffee beverage production device preferably further includes: a first flow channel for the hot water to flow through, which extends to the extraction unit; a second flow channel for the hot water to flow through, which extends to a coffee storage unit for storing the coffee beverage; and a flow channel selection unit configured to select, from among the first flow channel and the second flow channel, a flow channel through which the hot water is to flow. Prior to or subsequent to the extraction step which is executed when the first flow channel is selected by the flow channel selection unit, it is preferable that the flow channel selection unit selects the second flow channel, thereby executing a hot water addition step in which the hot water is delivered to the coffee storage unit. Here, the term “select” has, in addition to the meaning of completely switching the flow channel, the meaning of choosing the main distribution destination for the hot water.

Preferably, the target temperature in the hot water addition step is higher than the target temperature in the later period.

Preferably, the target temperature in the hot water addition step is higher than the target temperature in the earlier period.

Prior to the extraction step, it is preferable that the flow channel selection unit selects the first flow channel while the temperature control unit controls the heating unit to heat the water until steam is produced, and the steam is used to execute a first flow channel preheating step of preheating the first flow channel.

Prior to the hot water addition step, it is preferable that the flow channel selection unit selects the second flow channel while the temperature control unit controls the heating unit to heat the water until steam is produced, and the steam is used to execute a second flow channel preheating step of preheating the second flow channel.

Preferably, there are provided a plurality of operation modes, including a first operation mode in which the hot water addition step is executed, and a second operation mode in which the hot water addition step is not executed.

Preferably, a control is performed such that, after the hot water is supplied to the extraction unit, the flow channel selection unit selects the second flow channel until a subsequent time point of supplying the hot water.

Further, according to the present invention, there is provided a coffee beverage production program configured to cause a computer to function as: a temperature detection unit configured to detect a temperature of hot water obtained when water pumped by a pump is heated by a heating unit; and a temperature control unit configured to control the heating unit based on a temperature detected by the temperature detection unit such that the hot water reaches a target temperature, wherein, in an extraction step in which the hot water supplied by the pump is delivered to an extraction unit having set therein a coffee ingredient to extract a coffee beverage, as compared with the target temperature in an earlier period of the extraction step, the target temperature in a later period, which is a period of the extraction step subsequent to the earlier period, is a lower temperature.

### Advantageous Effects of Invention

According to the present invention, it is possible to provide a coffee beverage production device capable of extracting a coffee beverage having a cleaner taste with little astringency and harshness, and a production program thereof.

### BRIEF DESCRIPTION OF DRAWINGS

FIG. 1 is a functional block diagram of a coffee beverage production device according to an embodiment.

FIG. 2 shows graphs illustrating changes over time of the target temperature, the hot water temperature, a heater control signal, a pump control signal, and the selected flow channel in respective steps included in a coffee production process.

FIG. 3 shows graphs illustrating a first-half extraction period and a second-half extraction period, which occur in a case where an extraction step is divided into two such periods of first-half extraction period and second-half extraction period.

### DESCRIPTION OF EMBODIMENTS

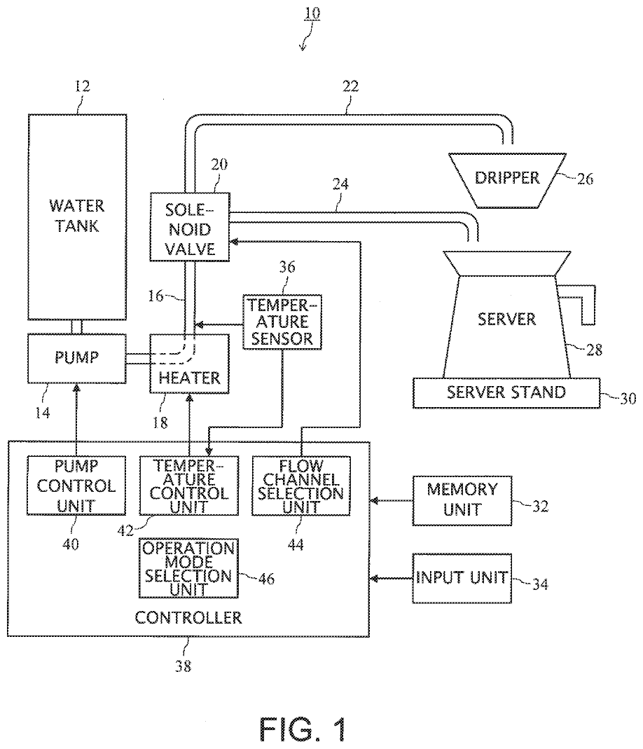

FIG. 1 is a functional block diagram of a coffee beverage production device 10 according to an embodiment. The coffee beverage production device 10 is a device for extracting a coffee beverage in a drip type system. In the device of the present embodiment, the actual extraction operation is automatically carried out according to a coffee beverage production program stored in the device, so that the user can operate the device by performing only minimum manipulations such as those related to the operation mode and the number of cups. The coffee beverage production device 10 may be a relatively small-sized device installed in a home, a workplace, or the like, or may be a relatively large-sized device installed in a coffee shop or the like.

A water tank 12 is a tank for storing water, which is made of, for example, resin or the like. The water tank 12 may be configured to be detachable from the body of the device. The water tank 12 stores water supplied by the user.

A pump 14 is an electric pump, such as a rotary pump that pumps water by means of rotation of a motor, or a vibration pump which is driven by electromagnetic force. In the present embodiment, a rotary pump is used as the pump 14. The pump 14 serving as a pumping unit is controlled by a pump control unit 40 described later, and pumps water stored in the water tank 12. In the present embodiment, the pump 14 pumps water from the water tank 12 to an upstream flow channel 16.

The upstream flow channel 16 is a water (or hot water) flow channel extending from the pump 14 to a solenoid valve 20, which will be described later.

A heater 18 serving as a heating unit is provided at a midpoint in the upstream flow channel 16, and is configured to heat the water pumped by the pump 14 to produce hot water or steam. In the present specification, regardless of temperature, water before being heated by the heater 18 is referred to as water, and water heated by the heater 18 is referred to as hot water. The heater 18 operates under the control of a temperature control unit 42, which will be described later.

The solenoid valve 20 is constituted by including, for example, a solenoid part having a coil, and a valve part. When the valve part is driven by having a current flowing through the coil, the flow channel downstream of the solenoid valve 20, through which the hot water that came flowing through the upstream flow channel 16 is to flow, is switched. The solenoid valve 20 operates under the control of a flow channel selection unit 44, which will be described later.

In the present embodiment, the solenoid valve 20 can be placed in either one of a main flow channel selection state, in which inflow of hot water from the upstream flow channel 16 to a main flow channel 22 is allowed and inflow of hot water from the upstream flow channel 16 to a bypass flow channel 24 is prohibited, and a bypass flow channel selection state, in which inflow of hot water from the upstream flow channel 16 to the main flow channel 22 is prohibited and inflow of hot water from the upstream flow channel 16 to the bypass flow channel 24 is allowed. Needless to mention, when the solenoid valve 20 is in the main flow channel selection state, hot water from the upstream flow channel 16 flows into the main flow channel 22 but does not flow into the bypass flow channel 24. When the solenoid valve 20 is in the bypass flow channel selection state, hot water from the upstream flow channel 16 does not flow into the main flow channel 22 but flows into the bypass flow channel 24.

In addition to the above-described states, the solenoid valve 20 may also be capable of being placed in a both flow channels selection state, in which inflow of hot water from the upstream flow channel 16 to both the main flow channel 22 and the bypass flow channel 24 is allowable. In such a both flow channels selection state, it is desirable to allow adjustment of the amount of hot water flowing into the main flow channel 22 and the amount of hot water flowing into the bypass flow channel 24. Further, the solenoid valve 20 may be capable of being placed in a flow channel non-selection state, in which inflow of hot water from the upstream flow channel 16 to each of the main flow channel 22 and the bypass flow channel 24 is prohibited.

The main flow channel 22 serving as a first flow channel is a flow channel for hot water to flow through, which extends from the solenoid valve 20 to a dripper 26 serving as an extraction unit. An opening of the main flow channel 22 on the dripper 26 side is located above the dripper 26. With this arrangement, the hot water that came flowing through the upstream flow channel 16 and the main flow channel 22 is delivered via this opening into the dripper 26.

The bypass flow channel 24 serving as a second flow channel is a flow channel for hot water to flow through, which extends from the solenoid valve 20 to a server 28 serving as a coffee storage unit. As will be described later, an opening of the bypass flow channel 24 on the server 28 side is located above the server 28 placed on a server stand 30. With this arrangement, the hot water that came flowing through the upstream flow channel 16 and the bypass flow channel 24 is delivered via this opening into the server 28. In other words, the hot water from the bypass flow channel 24 is delivered into the server 28 without passing through the dripper 26.

The dripper 26 has a funnel shape, with a large opening at the top and a small opening at the bottom. In the dripper 26, a filter such as a paper filter or a flannel filter is set by the user. This filter has an opening at the top in conformity with the shape of the dripper 26. Further, from the opening at the top of the filter, a coffee ingredient such as a coffee powder is set by the user. With the filter and the coffee ingredient set in the dripper 26, when hot water is delivered from the main flow channel 22, the hot water is poured on the coffee ingredient, and a coffee beverage is extracted. The extracted coffee beverage drops down from the bottom opening (not shown in drawing) of the dripper 26.

The server 28 stores the coffee beverage extracted by means of the dripper 26. The server 28 is removably placed on the server stand 30. The server stand 30 is located below the dripper 26. Accordingly, when the server 28 is placed on the server stand 30, the coffee beverage extracted in the dripper 26 and dropping from the dripper 26 is stored into the server 28 via an inlet provided on the upper side of the server 2. The server stand 30 is also located below the opening of the bypass flow channel 24 on the server 28 side. In other words, the server stand is arranged at a position such that, when the server 28 is placed on the server stand 30, the hot water delivered via the opening of the bypass flow channel 24 on the server 28 side is also stored into the server 28.

A memory unit 32 is constituted by including, for example, a ROM and a RAM.

The memory unit 32 stores therein a coffee beverage production program for operating a controller 38 described later. This production program may be configured to be updatable via a communication medium or a storage medium.

An input unit 34 is constituted by including, for example, a button, a touchscreen, and the like. The input unit 34 is used to input the user's instructions to the coffee beverage production device 10. The input unit 34 may be operably provided on a surface of the coffee beverage production device 10, or may be one for performing remote operations using a remote controller. In particular, the user uses the input unit 34 to provide instructions regarding the operation mode of the coffee beverage production device 10, the number of cups, and the start of a coffee production process.

A temperature sensor 36 serving as a temperature detection unit is constituted by including, for example, a thermistor and the like. The temperature sensor 36 is provided to directly or indirectly detect the temperature of hot water. In the present embodiment, the temperature sensor 36 detects the temperature of the hot water flowing through the upstream flow channel 16. Specifically, the temperature sensor 36 detects the temperature of the hot water immediately after being heated by the heater 18.

The controller 38 is constituted by including, for example, a microcomputer and the like. The controller 38 operates according to the coffee beverage production program stored in the memory unit 32 so as to function as the pump control unit 40, the temperature control unit 42, the flow channel selection unit 44, and an operation mode selection unit 46, as shown in FIG. 1.

The pump control unit 40 controls the rotation speed of the motor of the pump 14 to control pumping of water from the water tank 12 to the upstream flow channel 16. When the rotation speed of the motor of the pump 14 is higher, a larger amount of water is pumped from the water tank 12 to the upstream flow channel 16.

The temperature control unit 42 controls the heater 18 to control the temperature of hot water. Specifically, the temperature control unit 42 controls the heater 18 based on the temperature detected by the temperature sensor 36 such that the hot water temperature becomes equal to respective target temperatures set by the coffee beverage production program. In the present embodiment, the operation of the temperature control unit 42 will be described assuming that the heater 18 can only be placed in either the ON state (of heating water) or the OFF state (of not heating water). The temperature control unit 42 adjusts the time during which the heater 18 is ON (or the time during which the heater 18 is OFF) such that the hot water temperature is controlled to respective target temperatures. Obviously, the heater 18 control method of the temperature control unit 42 in the present embodiment is just one example, and, so long as the hot water temperature is controlled to target temperatures, it is possible to employ various temperature control methods according to the heater 18 type and the like. In the present embodiment, the temperature of the hot water flowing through the upstream flow channel 16 is detected, and this detected temperature does not strictly match the temperature inside the dripper 26. Therefore, in order for the dripper 26 to reach an intended temperature, each target temperature is set in consideration of predetermined external environment factors (such as ambient temperature and atmospheric pressure).

The flow channel selection unit 44 selects, from among the main flow channel 22 and the bypass flow channel 24, the flow channel through which the hot water from the upstream flow channel 16 is to flow. In the present embodiment, the flow channel selection unit 44 switches the state of the solenoid valve 20 between the main flow channel selection state and the bypass flow channel selection state, and thereby selects either one of the main flow channel 22 and the bypass flow channel 24 as the flow channel through which the hot water is to flow. In cases such as a case where the solenoid valve 20 can be placed in the both flow channels selection state in addition to the above-noted two selection states, or a case where, as will be described later, selection of the main flow channel 22 and the bypass flow channel 24 is possible without using the solenoid valve 20, the flow channel selection unit 44 can select both the main flow channel 22 and the bypass flow channel 24 as the flow channel through which hot water is to flow. In that case, it is desirable that the flow channel selection unit 44 can adjust the amount of hot water flowing into the main flow channel 22 and the amount of hot water flowing into the bypass flow channel 24. Further, the flow channel selection unit 44 may also be capable of selecting a both flow channels non-selection state, in which neither the main flow channel 22 nor the bypass flow channel 24 is selected as the flow channel through which hot water is to flow.

The operation mode selection unit 46 selects an operation mode of the coffee beverage production device 10 from among a plurality of operation modes prespecified by the coffee beverage production program. In accordance with the operation mode, the type of coffee beverage to be extracted is changed. In the present embodiment, the following three modes are provided in advance: a normal mode for extracting a coffee beverage having a normal concentration; an American-style mode for extracting a weaker coffee beverage than in the normal mode; and an iced coffee mode for extracting a coffee beverage for iced coffee. Prior to a coffee production process, the operation mode selection unit 46 selects an operation mode from these modes according to an instruction from the user. Obviously, the operation modes are not limited to the above, and other operation modes may be provided.

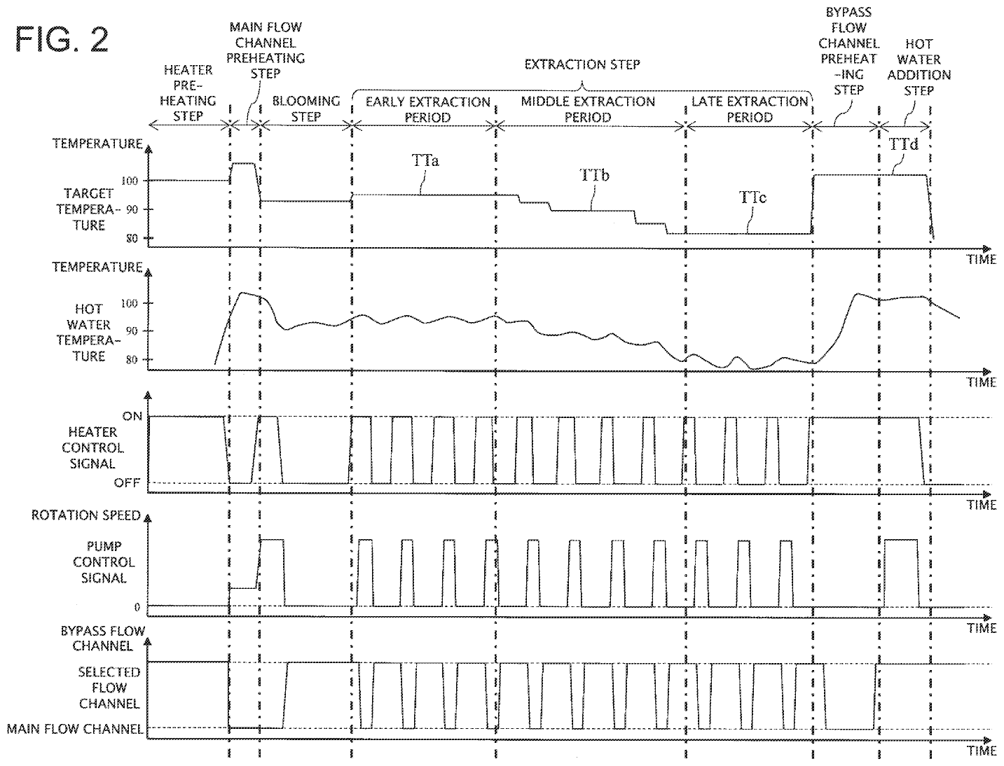

An overview of the configuration of the coffee beverage production device 10 is as described above. Next, by reference to FIG. 2, description will be given regarding a flow of a coffee production process in the coffee beverage production device 10, and also regarding details of processing in each of the functional units in the coffee beverage production device 10.

FIG. 2 refers to an example case in which two cups are to be extracted in the normal mode, and shows graphs illustrating changes over time of: the target temperature; the hot water temperature, which is the temperature detected by the temperature sensor 36; a heater control signal transmitted from the temperature control unit 42 to the heater 18; a pump control signal transmitted from the pump control unit 40 to the pump 14; and the selected flow channel selected by the flow channel selection unit 44, in respective steps included in the coffee production process. In each graph included in FIG. 2, the horizontal axis represents time, while the vertical axis indicates individual values. In order to achieve an optimum control according to the operation mode and the number of cups to be extracted, time points of control and amounts of control for the respective control units are stored in advance in the memory unit 32 as parameters, and are set by the coffee beverage production program as appropriate according to the operation mode and the number of cups.

The target temperature at respective time points in each step shown in FIG. 2 is preset in the coffee production process program. The heater control signal to be output by the temperature control unit 42 is determined based on the detection temperature of the temperature sensor 36 (that is, the hot water temperature) and the target temperature. Accordingly, even when the target temperature remains the same, the graph of the heater control signal may show changes according to the hot water temperature, which may be varied due to the outside air temperature and the like. Further, the pump control signal and the selected flow channel in each step shown in FIG. 2 are also preset in the coffee production process program.

As shown in FIG. 2, the coffee production process includes a heater preheating step, a main flow channel preheating step, a blooming step, an extraction step, a bypass flow channel preheating step, and a hot water addition step. In the present embodiment, the respective steps are sequentially executed in the above order as operations according to the coffee production process program are performed. Upon execution of the steps, the user is required to put water in the water tank 12, set the filter and the coffee ingredient in the dripper 26, place the server 28 on the server stand 30, input extraction conditions such as the operation mode via the input unit 34, and start the coffee production process. As a result of doing so, the coffee beverage production device 10 automatically (i.e., without requiring user manipulation) and sequentially executes the above-described steps starting from the heater preheating step.

The heater preheating step is a step of preheating the heater 18. In the heater preheating step, the temperature control unit 42 controls the heater 18 to maintain the “ON” state for a predetermined duration. As a result, the heater 18 is preheated. In the heater preheating step, since it is not necessary to pump water, the pump control unit 40 controls the speed of rotation of the pump 14 to “0”. There may be cases where, due to the preheating of the heater 18, the water remaining in the upstream flow channel 16 becomes hot water and moves to the downstream side. In order to prevent delivery of this hot water from the main flow channel 22 to the dripper 26 and to prevent pouring of undesired hot water on the coffee ingredient set in the dripper 26, the flow channel selection unit 44 controls the solenoid valve 20 to prohibit inflow of hot water into the main flow channel 22. In the present embodiment, the flow channel selection unit 44 performs a control to place the solenoid valve 20 in the bypass flow channel selection state. As a result, the water (or hot water) remaining in the upstream flow channel 16 is delivered to the server 28. When it is not desired to deliver the water (or hot water) remaining in the upstream flow channel 16 to the server 28, the flow channel selection unit 44 may perform a control to place the solenoid valve 20 in the flow channel non-selection state.

The main flow channel preheating step, which serves as a first flow channel preheating step, is a step of preheating the main flow channel 22 prior to the subsequent blooming step or extraction step. In the present embodiment, in the main flow channel preheating step, a very small amount of water pumped by the pump 14 is converted into steam using the heater 18, and this steam is circulated through the main flow channel 22 to preheat the main flow channel 22. Although it is also possible to preheat the main flow channel 22 by causing hot water to flow into the main flow channel 22, if such is done, hot water might be delivered to the dripper 26 and undesired hot water might be delivered to the dripper 26 in the main flow channel preheating step. In the present embodiment, by preheating the main flow channel 22 with steam, delivery of undesired hot water to the dripper 26 is prevented.

In the main flow channel preheating step, the temperature control unit 42 controls the heater 18 such that the water pumped by the pump 14 is converted into steam. As shown in the graph showing the hot water temperature in FIG. 2, in the main flow channel preheating step, the hot water temperature exceeds 100° C.; that is, the water is in the form of steam. In the present embodiment, since the preheating in the heater preheating step enables the heater 18 to apply heat sufficient for converting water into steam, the heater 18 is controlled to the OFF state for the time being in the main flow channel preheating step. If, after the heater preheating step, the amount of heating by the heater 18 is insufficient for converting water into steam, the temperature control unit 42 maintains the ON state of the heater 18 in the main flow channel preheating step.

In the main flow channel preheating step, the flow channel selection unit 44 selects the main flow channel 22 in order to allow the steam to flow into the main flow channel 22. In the present embodiment, the flow channel selection unit 44 performs a control to place the solenoid valve 20 in the main flow channel selection state. As a result, the steam from the upstream flow channel 16 flows into the main flow channel 22, and does not flow into the bypass flow channel 24. According to another embodiment, the flow channel selection unit 44 may, at this time, perform a control to select both the main flow channel 22 and the bypass flow channel 24. Further, as shown in FIG. 2, in the main flow channel preheating step, in order to allow steam to flow into the main flow channel 22, the pump 14 is controlled to rotate at a lower rotation speed than in other, subsequent steps, so that water for obtaining an amount of steam sufficient for preheating the main flow channel 22 is pumped to the upstream flow channel 16.

The blooming step is a step of pouring a predetermined amount of hot water on the coffee ingredient set in the dripper 26 and taking a certain wait time before moving on to the extraction step.

In the blooming step, the temperature control unit 42 controls the heater 18 such that the hot water temperature reaches a temperature suitable for blooming. In the present embodiment, the target temperature of the temperature control unit 42 in the blooming step is slightly lower than the target temperature (i.e., the target temperature TTa in FIG. 2) in an early extraction period, which is the earlier period of the subsequent extraction step. Specifically, in the present embodiment, the target temperature in the blooming step is set to a temperature in the lower 90s (° C.).

In the blooming step, with the main flow channel 22 being selected by the flow channel selection unit 44, the pump control unit 40 controls the rotation speed of the pump 14 such that a predetermined amount of hot water required for blooming is delivered from the main flow channel 22 to the dripper 26 in a predetermined duration. Subsequently, the pump control unit 40 sets the speed of rotation of the pump 14 to “0” and stops delivery of hot water from the pump 14. In that state, blooming of the coffee ingredient is executed by waiting for several tens of seconds (for example, 20 to 60 seconds). During that time, the hot water temperature in the upstream flow channel 16 is maintained by residual heat.

Next, the extraction step will be described. The extraction step in the present embodiment is a step of extracting a coffee beverage by delivering hot water to the coffee ingredient over a predetermined duration. In the present embodiment, hot water is intermittently delivered to the coffee ingredient in the extraction step. In the coffee beverage production device 10, the extraction step is divided into a plurality of periods. In the present embodiment, the extraction step is divided into three periods of: the early extraction period, which is the earlier period; and a middle extraction period and a late extraction period, which correspond to the later period following the earlier period. The extraction step may be composed of two periods as described later, or may be composed of four or more periods.

In the present embodiment, in the extraction step, the target temperature of the temperature control unit 42 is set increasingly lower as time passes from the start of extraction. That is, the temperature control unit 42 controls the heater 18 such that the temperature of hot water becomes lower as time passes from the start of extraction.

Therefore, even in the course of the temperature decrease, ON/OFF controls of the heater 18 are performed. As can be seen from FIG. 2, as compared with the target temperature TTa in the early extraction period, the target temperature TTb in the middle extraction period and the target temperature TTc in the late extraction period are lower temperatures. Further, as compared with the target temperature TTb in the middle extraction period, the target temperature TTc in the late extraction period is a lower temperature. Specifically, in the present embodiment, the target temperature TTa in the early extraction period is about 95° C., the target temperature TTb in the middle extraction period is about 90° C., and the target temperature TTc in the late extraction period is about 80° C.

Here, while it is noted that the target temperature can be varied within each period of the extraction process, according to the above description that the target temperature in the middle extraction period is lower than the target temperature in the early extraction period, it is not necessarily the case that the target temperature at every time point in the middle extraction period is lower than the target temperature in the early extraction period. In other words, the target temperature may be set such that the hot water temperature in the middle extraction period becomes substantially lower than the hot water temperature in the early extraction period. For example, assuming that the target temperature in the early extraction period is TTa, even when the target temperature in a short duration of time within the middle extraction period is higher than TTa, so long as the target temperature is lower than TTa in other durations in the middle extraction period and the hot water temperature in the middle extraction period is substantially lower than the temperature of the hot water in the early extraction period, it can be said that the target temperature TTb in the middle extraction period is lower than the target temperature TTa in the early extraction period. This applies similarly to the relationship between other periods (or to the hot water addition step described later).

Further, the target temperature in each period (or in the hot water addition step) may be defined as a time average value of the target temperature within the period or within the hot water addition step, or as a time average value of the hot water temperature that reflects the target temperature. In that case, for example, the time average value of the target temperature or hot water temperature in the middle extraction period is to be compared with the time average value of the target temperature or hot water temperature in the early extraction period. Another definition can be contemplated from the perspective of the amount of extraction in the early extraction period and the amount of extraction in the middle extraction period. A comparison is to be made between the time average value of each target temperature or hot water temperature for an amount of extraction in the early extraction period, and the time average value of each target temperature or hot water temperature for an amount of extraction in the middle extraction period.

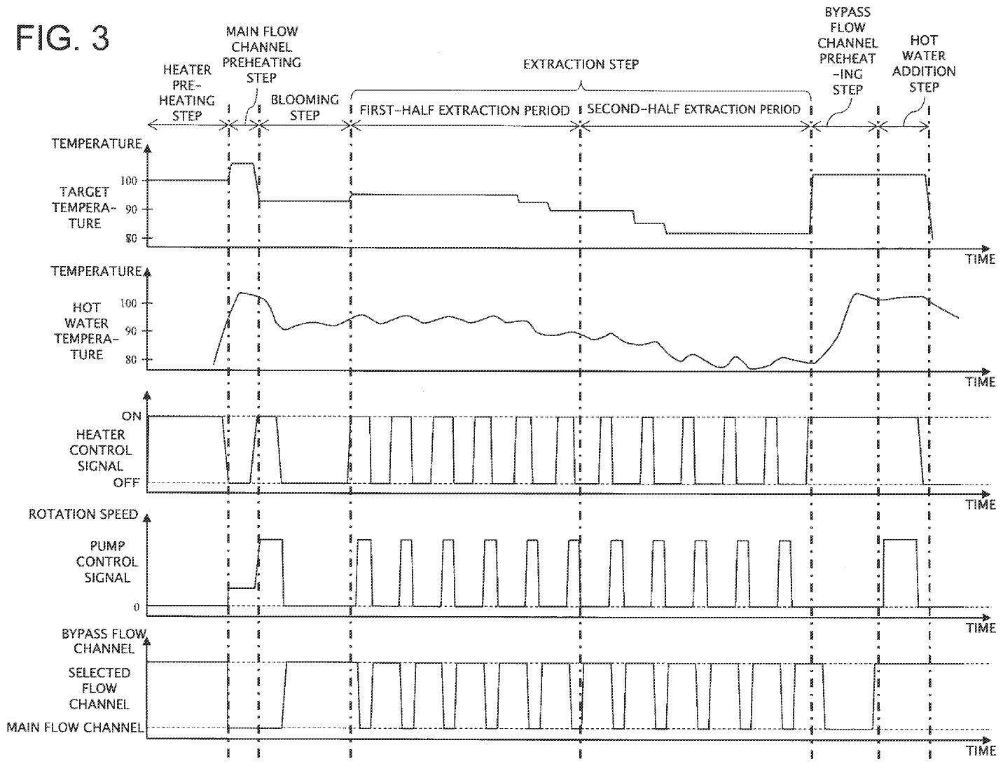

Although in the present embodiment the extraction step is divided into three periods as described above, the extraction step may alternatively be divided into two periods to control the target temperature. FIG. 3 shows graphs illustrating a case where the extraction process is divided into two periods. In the example of FIG. 3, the first-half extraction period corresponds to the earlier period, and the second-half extraction period corresponds to the later period. While this is not a limitation, in the example of FIG. 3, the first-half extraction period is the earlier half period of the extraction step, and the second-half extraction period is the latter half period of the extraction step.

As shown in FIG. 3, when the extraction step is divided into the first-half extraction period and the second-half extraction period, the temperature control unit 42 controls the heater 18 such that the time average value of the target temperature in the second-half extraction period becomes a value lower than the time average value of the target temperature in the first-half extraction period.

Returning to FIG. 2, in the extraction step, with the main flow channel 22 being selected by the flow channel selection unit 44, the pump control unit 40 rotates the pump 14, and hot water is delivered to the dripper 26. In the present embodiment, in order to finely control the temperature and the amount of hot water, the pump control unit 40 intermittently rotates the pump 14 (that is, the pump 14 is repeatedly rotated and stopped), and hot water is intermittently delivered to the dripper 26. In the example of FIG. 2, the flow channel selection unit 44 selects the main flow channel 22 while the pump 14 is rotating, and selects the bypass flow channel 24 while the pump 14 is not rotating. However, it is also possible to employ a simple control method in which the flow channel selection unit 44 performs a control to select the main flow channel 22 throughout the extraction step.

As described above, in the extraction step, hot water is intermittently delivered to the dripper 26 in a plurality of separate times.

Although detailed description will not be given since the basic operations during extraction are the same as in FIG. 2, in order to achieve an optimum control according to the operation mode and the number of cups, time points of control and amounts of control for the respective control units are stored in advance in the memory unit 32, and are set by the coffee beverage production program as appropriate according to the operation mode and the number of cups. According to this arrangement, for example, when hot water is to be intermittently delivered to the dripper 26 in a plurality of separate times, it is possible to control the amount of hot water delivered each time to be different between the normal mode and the American-style mode.

As noted above, a greater amount of sweetness and acidity components are extracted immediately after start of extraction of a coffee beverage, and as time passes from the start of extraction, more astringency and harshness components are extracted. Further, when the temperature of hot water is higher, the extracted coffee beverage has a higher concentration (that is, more components are extracted from the coffee ingredient), and when the temperature of hot water is lower, the extracted coffee beverage has a lower concentration (that is, less components are extracted from the coffee ingredient).

Therefore, in the present embodiment, by raising the target temperature and thereby raising the temperature of hot water delivered to the dripper 26 in the earlier period (i.e., the early extraction period) of the extraction step, a greater amount of sweetness and acidity components are extracted, and by lowering the target temperature and thereby lowering the temperature of hot water delivered to the dripper 26 in the later period (i.e., the middle extraction period and the late extraction period) following the earlier period, a coffee beverage having a cleaner taste with little astringency and harshness is extracted as compared with the case where a constant temperature control is executed.

Further, although in the present embodiment the early extraction period, which is the earlier period, is the first period of the extraction step, the earlier period is not necessarily the first period of the extraction step. It is sufficient so long as, in the extraction step, the earlier period is (temporally) before the later period. Nevertheless, since a greater amount of sweetness and acidity components are extracted in a period occurring earlier in the extraction step, it is desirable that the earlier period is arranged in the earlier part of the extraction step.

The bypass flow channel preheating step, which serves as the second flow channel preheating step, is a step of preheating the bypass flow channel 24 prior to the subsequent hot water addition step. According to the present embodiment, in the bypass flow channel preheating step, as in the main flow channel preheating step, the target temperature, which has been lowered for extraction, is raised to a temperature suitable for preheating, and then a control to switch the flow channel from the main flow channel 22 to the bypass flow channel 24 is performed by the flow channel selection unit 44.

In the bypass flow channel preheating step, the temperature control unit 42 controls the heater 18 such that the water that has been pumped by the pump 14 in the extraction step and that remains in the upstream flow channel 16 is converted into steam. The temperature control unit 42 turns the heater 18 to the ON state, and heats the water remaining in the upstream flow channel 16 until it is converted into steam.

In the bypass flow channel preheating step, the flow channel selection unit 44 selects the bypass flow channel 24 in order to allow steam to flow into the bypass flow channel 24. In the present embodiment, the flow channel selection unit 44 performs a control to place the solenoid valve 20 in the bypass flow channel selection state. As a result, the steam from the upstream flow channel 16 flows into the bypass flow channel 24, and does not flow into the main flow channel 22. By circulating the steam in the bypass flow channel 24, the bypass flow channel 24 is preheated. According to another embodiment, the flow channel selection unit 44 may, at this time, select both the main flow channel 22 and the bypass flow channel 24. Further, in the present embodiment, in the bypass flow channel preheating step, since the water remaining in the upstream flow channel 16 is converted into steam and caused to flow into the bypass flow channel 24, the pump control unit 40 does not rotate the pump 14 in the bypass flow channel preheating step. However, as in the main flow channel preheating step, the pump 14 may be controlled to rotate at a low speed in the bypass flow channel preheating step, so that water for obtaining an amount of steam sufficient for preheating the bypass flow channel 24 is pumped to the upstream flow channel 16.

The hot water addition step is a step of delivering hot water from the bypass flow channel 24 to the server 28.

In the present embodiment, the target temperature TTd of the temperature control unit 42 in the hot water addition step is higher than the target temperature in the later period of the extraction step. Specifically, the target temperature TTd in the hot water addition step is at least higher than the target temperature TTc in the late extraction period, which is the last period of the extraction step. Preferably, the target temperature TTd in the hot water addition step is higher than the target temperature TTb in the middle extraction period, which is the first period in the later period of the extraction step. More preferably, the target temperature TTd in the hot water addition step is higher than the target temperature TTa in the early extraction period, which is the first period of the extraction step, and such is the case in the present embodiment. Specifically, in the present embodiment, the target temperature TTd in the hot water addition step is 100° C.

In the hot water addition step, with the bypass flow channel 24 being selected by the flow channel selection unit 44, the pump control unit 40 controls the pump 14 such that hot water is delivered from the bypass flow channel 24 to the server 28. In the hot water addition step, in a case where delivery of a large amount of hot water to the server 28 at one time results in a decrease in the temperature of the delivered hot water, it is desirable that the pump control unit 40 causes the pump 14 to pump water with short breaks in between.

As noted above, in the extraction step, in order to extract a coffee beverage having a cleaner taste with little astringency and harshness, the temperature control unit 42 lowers the temperature of the hot water to be delivered to the dripper 26 in the middle extraction period and the late extraction period. Meanwhile, by performing such a control, the temperature of the coffee beverage stored in the server may become lower than the optimum temperature. In the present embodiment, instead of employing a configuration in which a heating means is provided in the server stand to maintain the temperature at a suitable level, the temperature of the coffee beverage stored in the server 28 is increased to approach the suitable level by setting the target temperature in the hot water addition step higher than at least that in the late extraction period; that is, by causing the temperature of hot water in the hot water addition step to be higher than at least that in the late extraction period. With this arrangement, it is possible to obtain the advantageous effect that the user can taste the coffee beverage at a suitable temperature.

Furthermore, since only addition of hot water is performed, the clean taste of the coffee beverage extracted in the extraction step can be maintained.

The coffee production process in the coffee beverage production device 10 is completed by the series of steps from the heater preheating step to the hot water addition step described above.

Although in the present embodiment the hot water addition step is executed after the extraction step, the hot water addition step may be executed before the extraction step. Needless to mention, even in that case, the bypass flow channel preheating step is to be executed prior to the hot water addition step, and accordingly, the bypass flow channel preheating step would be executed before the extraction step. Further, the hot water addition step may be executed before and after the extraction step.

Further, execution of the extraction step and the hot water addition step at the same time may be considered, and such an embodiment can actually be adopted in the coffee beverage production device 10. However, since the target temperature (or the hot water temperature) differs between the extraction step and the hot water addition step as described above, when the extraction step and the hot water addition step are to be executed at the same time, at least two heaters 18 (and temperature sensors 36) would be required. For example, it would be necessary to provide heaters 18 in the main flow channel 22 and the bypass flow channel 24, respectively. This would result in making the structure of the coffee beverage production device 10 more complex and increasing the cost or size of the coffee beverage production device 10. Therefore, in terms of cost reduction or downsizing of the coffee beverage production device 10, a case where the hot water addition step is executed before or after the extraction step is advantageous over a case where the extraction step and the hot water addition step are executed at the same time.

Further, the hot water addition step may be optional. While it is noted that, in the present embodiment, the coffee beverage production device 10 has the operation modes including the normal mode, the American-style mode, and the iced coffee mode as described above, whether or not to execute the hot water addition step is determined according to the operation mode. Specifically, when the operation mode selection unit 46 selects the normal mode or the American-style mode, which is the first operation mode, the hot water addition step is executed, and when the operation mode selection unit 46 selects the iced coffee mode, which is the second operation mode, the hot water addition step is not executed. When the hot water addition step is not executed, at least it is no longer necessary to have the flow channel selection unit 44 perform a control to switch the flow channel from the main flow channel 22 to the bypass flow channel 24. Further, the amount of hot water delivered in the hot water addition step may be increased in the American-style mode, as compared with that in the normal mode, to thereby adjust the concentration.

Furthermore, in addition to the hot water addition step and the bypass flow channel preheating step, the main flow channel preheating step and the blooming step may be made optional, and there can further be provided an operation mode that requires a shorter time for the coffee production process. Whether or not to execute the main flow channel preheating step and the blooming step may also be determined according to the operation mode of the coffee beverage production device 10.

Further, although in the present embodiment the switching of the hot water flow channel is executed using the solenoid valve 20, other means may be used to switch the flow channel for hot water. For example, both the main flow channel 22 and the bypass flow channel 24 may be directly connected to the water tank 12. In that case, a set consisting of a pump 14, a heater 18, and a temperature sensor 36 is provided for each of the main flow channel 22 and the bypass flow channel 24. In that case, when the flow channel selection unit 44 selects the main flow channel 22, the pump control unit 40 operates the pump 14 of the main flow channel 22 to pump water in the water tank 12 to the main flow channel 22, and when the flow channel selection unit 44 selects the bypass flow channel 24, the pump control unit 40 operates the pump 14 of the bypass flow channel 24 to pump water in the water tank 12 to the bypass flow channel 24. The temperature control unit 42 controls the heater 18 of the main flow channel 22 based on the temperature sensor 36 of the main flow channel 22 and the target temperature so as to execute the main flow channel preheating step, the blooming step, and the extraction step, and controls the heater 18 of the bypass flow channel 24 based on the temperature sensor 36 of the bypass flow channel 24 and the target temperature so as to execute the bypass flow channel preheating step and the hot water addition step.

While embodiments according to the present invention have been described above, the present invention is not limited to the above embodiments, and various modifications can be made without departing from the spirit of the present invention.

### REFERENCE SIGNS LIST

10 coffee beverage production device; 12 water tank; 14 pump; 16 upstream flow channel; 18 heater; 20 solenoid valve; 22 main flow channel; 24 bypass flow channel; 26 dripper; 28 server; 30 server stand; 32 memory unit; 34 input unit; 36 temperature sensor; 38 controller; 40 pump control unit; 42 temperature control unit; 44 flow channel selection unit.

1. A coffee beverage production device, comprising:
a heating unit configured to produce hot water by heating water pumped by a pump; a temperature detection unit configured to detect a temperature of the hot water;
a temperature control unit configured to control the heating unit based on a temperature detected by the temperature detection unit such that the hot water reaches a target temperature;
a first flow channel for the hot water to flow through, which extends to an extraction unit having set therein a coffee ingredient;
a second flow channel for the hot water to flow through, which extends to a coffee storage unit for storing a coffee beverage; and
a flow channel selection unit configured to select, from among the first flow channel and the second flow channel, a flow channel through which the hot water flows, wherein
in an extraction step in which the hot water supplied by the pump is delivered to the extraction unit to extract the coffee beverage, as compared with the target temperature in an earlier period of the extraction step, the target temperature in a later period, which is a period of the extraction step following the earlier period, is a lower temperature,
prior to or subsequent to the extraction step which is executed when the first flow channel is selected by the flow channel selection unit, the flow channel selection unit selects the second flow channel, thereby executing a hot water addition step in which the hot water is delivered to the coffee storage unit, and
subsequent to a user's input of an instruction to deliver the coffee beverage and the hot water to the coffee storage unit, a series of steps including the extraction step and the hot water addition step are successively executed.

2. The coffee beverage production device according to claim 1, wherein
a time average value of the target temperature in the later period is a value lower than a time average value of the target temperature in the earlier period.

3. The coffee beverage production device according to claim 2, wherein
the earlier period is a first-half period of the extraction step, and the later period is a second-half period of the extraction step.

4. (canceled)

5. The coffee beverage production device according to claim 1, wherein
the target temperature in the hot water addition step is higher than the target temperature in the later period.

6. The coffee beverage production device according to claim 5, wherein
the target temperature in the hot water addition step is higher than the target temperature in the earlier period.

7. The coffee beverage production device according to claim 1, wherein
prior to the extraction step, the flow channel selection unit selects the first flow channel while the temperature control unit controls the heating unit to heat the water until steam is produced, and the steam is used to execute a first flow channel preheating step of preheating the first flow channel.

8. The coffee beverage production device according to claim 1, wherein
prior to the hot water addition step, the flow channel selection unit selects the second flow channel while the temperature control unit controls the heating unit to heat the water until steam is produced, and the steam is used to execute a second flow channel preheating step of preheating the second flow channel.

9. The coffee beverage production device according to claim 1, having
a plurality of operation modes, including a first operation mode in which the hot water addition step is executed, and a second operation mode in which the hot water addition step is not executed.

10. The coffee beverage production device according to claim 1, wherein
a control is performed such that, after the hot water is supplied to the extraction unit, the flow channel selection unit selects the second flow channel until a subsequent time point of supplying the hot water.

11. A coffee beverage production program configured to cause a computer to function as:
a temperature detection unit configured to detect a temperature of hot water obtained when water pumped by a pump is heated by a heating unit;
a temperature control unit configured to control the heating unit based on a temperature detected by the temperature detection unit such that the hot water reaches a target temperature; and
a flow channel selection unit configured to select a flow channel through which the hot water flows, from among a first flow channel for the hot water to flow through, the first flow channel extending to an extraction unit having set therein a coffee ingredient and a second flow channel for the hot water to flow through, the second flow channel extending to a coffee storage unit for storing a coffee beverage, wherein
in an extraction step in which the hot water supplied by the pump is delivered to the extraction unit to extract the coffee beverage, as compared to the target temperature in an earlier period of the extraction step, the target temperature in a later period, which is a period of the extraction step subsequent to the earlier period, is a lower temperature,
prior to or subsequent to the extraction step which is executed when the first flow channel is selected by the flow channel selection unit, the flow channel selection unit selects the second flow channel, thereby executing a hot water addition step in which the hot water is delivered to the coffee storage unit, and
subsequent to a user's input of an instruction to deliver the coffee beverage and the hot water to the coffee storage unit, a series of steps including the extraction step and the hot water addition step are successively executed.
